(19) United States
(12) Patent Application Publication
(10) Pub. No.: US 2004/0181806 A1
(43) Pub. Date: Sep. 16, 2004

(54) Method and apparatus for transmitting digital video signals in a digital visual interface format over an RF cable

(75) Inventor: Daniel E. Sullivan, Shoreview, MN (US)

Correspondence Address: ALTERA LAW GROUP, LLC, 6500 CITY WEST PARKWAY, SUITE 100, MINNEAPOLIS, MN, 55344-7704, US

(73) Assignee: Visual Circuits Corporation, Fridley, MN

(21) Appl. No.: 10/386,969

(22) Filed: Mar. 11, 2003

(51) Int. Cl. H04N 7/20; H04N 7/16

(52) U.S. Cl. 725/73; 725/148

(57) ABSTRACT

The present invention is a system for transmitting and receiving video signals in a digital visual interface (DVI) format over and an RF cable. The transmission and reception includes optionally scaling the video signals to plasma native resolution. Also, the transmission of the signals may be performed by varying rates of lossless or visually lossless compression and digitally modulated the signal to be transmitted over an RF cable.

### BACKGROUND OF THE INVENTION

1. Field of the Invention

The present invention relates generally to digital transmission and advertising. More particularly, the present invention relates to a method and apparatus for transmitting digital video signals in a digital visual interface (DVI) format over an RF cable.

2. Description of Related Art

Commercial network television has been recognized as a powerful and efficient medium for broadcasting advertising messages to a large, widely disbursed audience. However, advertising dollars are ineffectively spent on messages that reach the wrong audiences under the wrong circumstances. Further, national network television is well suited only for the limited number of product categories that are truly national in scope and relatively impervious to regional and seasonal variation.

Point of purchase advertising accomplishes what in-home television cannot, in large part because point of purchase advertising is directed not toward passive, unreceptive viewers, but rather toward consumers who are actively making choices and seeking information. However, current point of purchase advertising programs have severe limitations. For the most part they are based on a static, print-oriented media.

Ample evidence demonstrates consumers in a shopping environment are much more susceptible to televised or computerized messages than otherwise. These messages can be transmitted to and received from remote displays over wireless devices within shopping environments. However, transmitted messages are especially susceptible to surrounding signal interference and security breaches in these environments. Also, additional hardware, such as multiple transmitters and receivers, is required for wireless operations in these environments. Many retailer and other businesses would prefer to use existing wiring already installed in their facilities. Using existing wiring would greatly reduce installation time and eliminate the additional hardware costs.

Computers can control display information, which may optionally include textual information as for slides, video data, audio data, or a combination thereof. The computer transmits such information to a monitor connected to the computer by a cable. However, computers are not sufficiently portable and require additional hardware for remotely displaying the information. Thus, the computer must be in close proximity to the display, which can be inconvenient, particularly when the operator of the computer wishes to display the information on multiple remote displays.

Another limitation to computer control of display information is the computer's analog video graphics array (VGA) interfaces. Analog video graphics array (VGA) interfaces, such as those used in current analog CRTs, do not have the ability to incorporate the encryption strength required by certain industries to ensure against unauthorized copying.

Digital flat-panel display interfaces create additional problems for displaying information. For the most part, these displays are currently connected to an analog video graphics array (VGA) interface and, thus, require a double signal conversion. The digital signal from the computer must be converted to an analog signal for the analog VGA interface, and then converted back to a digital signal for processing by the flat-panel display. This inherently inefficient process takes a toll on video quality.

However, one of the problems associated with the display interfaces can be corrected using a digital visual interface (DVI). A digital visual interface cable connecting the computer to the display eliminates the digital-to-analog conversion required by the VGA interface. This interface can provide a lossless transfer of data. However, the DVI cable can only transmit signals a short distance, i.e. approximately 75 feet, and up to 150 ft. with a DVI repeater. Furthermore, the repeater requires an installation of additional cabling and hardware, a costly venture. Also, the repeater connection is limited to one repeater connected between one source and one display.

It can be seen that there is a need to digitally modulate and transmit digital video signals over long distances.

It can be seen that there is a need for transmitting digital video signals in a digital visual interface format over an existing RF cable infrastructure.

### SUMMARY OF THE INVENTION

To overcome the limitations in the prior art described above, and to overcome other limitations that will become apparent upon reading and understanding the present specification, the present invention discloses a method and apparatus for transmitting digital video signals in a digital visual interface format over an RF cable.

The present invention solves the above-described problems by allowing retailers and other businesses to provide information directly to their clients by preparing and transmitting digital video signals over long distances. This is accomplished by digitally modulating digital video signals before transmitting the digital video signals over an RF cable medium to one or more remote locations.

A method of transmitting digital video signals in a digital visual interface format in accordance with the principles of the present invention includes processing at least one digital video signal in a DVI standard interface to generate at least one video signal in a DVI standard format, and digitally modulating the at least one digital video signal in the digital visual interface format for transmission over an RF cable.

In another embodiment a method of transmitting digital video signals over long distances using an RF cable is provided. The method of transmitting digital video signals includes digitally processing at least one video signal to generate at least one digital video signal at a plasma screen native resolution, and digitally modulating the at least one digital video signal at the plasma screen native resolution for transmission over an RF cable.

In another embodiment a method of displaying digital video signals is provided. The method of displaying digital video signals includes receiving, at a receiving device, at least one digitally modulated video signal in a digital visual interface format transmitted over the RF cable, processing the at least one digitally modulated video signal to generate at least one video signal, and displaying the at least one video signal on a display.

In another embodiment a method of processing digital video signals is provided. The method of processing digital video signals includes processing, at a transmitting device, at least one digital video signal in a DVI standard interface to generate at least one video signal in the DVI standard format, digitally modulating, at the transmitting device, the at least one digital video signal in the digital visual interface format for transmission over an RF cable, and receiving, at a receiving device, the at least one digitally modulated digital video signal in the DVI standard format transmitted over the RF cable.

In another embodiment a system for transmitting digital video signals in a digital visual interface format is provided. The system includes a processor for processing at least one digital video signal in a DVI standard interface to generate at least one video signal in the DVI standard format, and a modulator for digitally modulating the at least one digital video signal in the digital visual interface format for transmission over an RF cable.

In another embodiment a system for transmitting digital video signals in a digital visual interface format is provided. The system includes a memory for storing at least one video signal, and a digital signal processor for processing the at least one video signal to generate at least one digital modulated video signal in the DVI standard format for transmission over an RF cable.

In another embodiment an article of manufacture is provided. The article of manufacture includes a program storage medium readable by a computer, the medium tangibly embodying one or more programs of instructions executable by the computer to perform a method for transmitting digital video signals in a digital visual interface format, the method includes processing at least one digital video signal in a DVI standard interface to generate at least one video signal in a DVI standard format, and digitally modulating the at least one digital video signal in the digital visual interface format for transmission over an RF cable.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 is a functional block diagram of a RF digital cable transmission system in accordance with the invention;

FIG. 2 illustrates a hardware environment for transmitting digital video signals in a digital visual interface format over an RF cable;

FIG. 3 illustrates another embodiment of a hardware environment for transmitting digital video signals in a digital visual interface format over an RF cable;

FIG. 4 is a flow chart illustrating a method for transmitting digital video signals in a digital visual interface format over an RF cable;

FIG. 5 is a functional block diagram of a RF digital cable receiving system in accordance with the invention; and

FIG. 6 illustrates a system that is configured to transmit digital video signals in a digital video interface format over an RF cable according to the invention using an executable program readable from a storage driver program.

### DETAILED DESCRIPTION OF THE INVENTION

In the following description of the exemplary embodiment, reference is made to the accompanying drawings, which form a part hereof, and in which is shown by way of illustration the specific embodiment in which the invention may be practiced. It is to be understood that other embodiments may be utilized as structural changes may be made without departing from the scope of the present invention.

The present invention delivers high-quality, high bit-rate video information directly to retailer and other business clients by preparing and transmitting digital video signals over long distances. This is accomplished by digitally modulating the digital video signal before transmitting the digital video signal over an RF cable medium to one or more remote locations, e.g., directly to multiple display devices on a display floor in the retail environment.

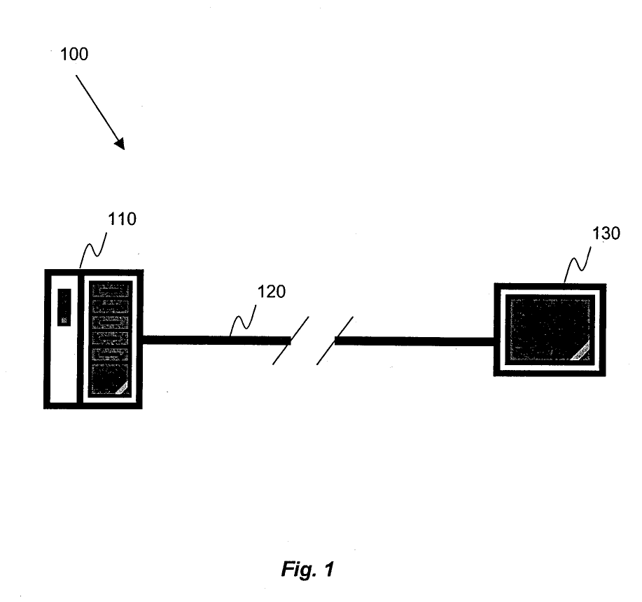

FIG. 1 is a functional block diagram of a RF digital cable transmission system 100 in accordance with the invention. The source unit 110 is connected to an RF cable transmission line 120. The source unit 110 includes a transmitter for the transmission of signals (e.g., data, voice, video, and the like). For example, the source unit 110 may be a video server capable of delivering between 4 and 32 channels of video within a single system, offering high bit-rate video, precise control of all video and audio channels, and full data redundancy. However, sources of video, audio and data are not limited to the source device 110 and can be provided, for example, over wired networks, wireless networks, or a similar source device. Information is transmitted through the RF cable 120 and may be received on a display device 130. Information transmitted through the RF cable 120 can be transmitted via a single channel or via multiple channels.

Examples of display screen 130 include but are not limited to any type of flat screen including a plasma screen or an LCD (liquid crystal display), a CRT (cathode ray tube) monitor, a computer monitor or any other type of video display monitor. Furthermore, when a flat-panel display is connected to a digital interface, no digital-to-analog conversion is required. Thus, display 130 enables visual data such as a GUI (graphical user interface), other graphics or images, or a video stream, to be displayed to a viewer.

The system 100 can include multiple source units 110 and multiple displays 130. A source unit 110 and a display 130 of the system 100 can be located in different areas. For example, the source unit 110 and the display 130 may be separated by several floors in a building or located in different geographical areas.

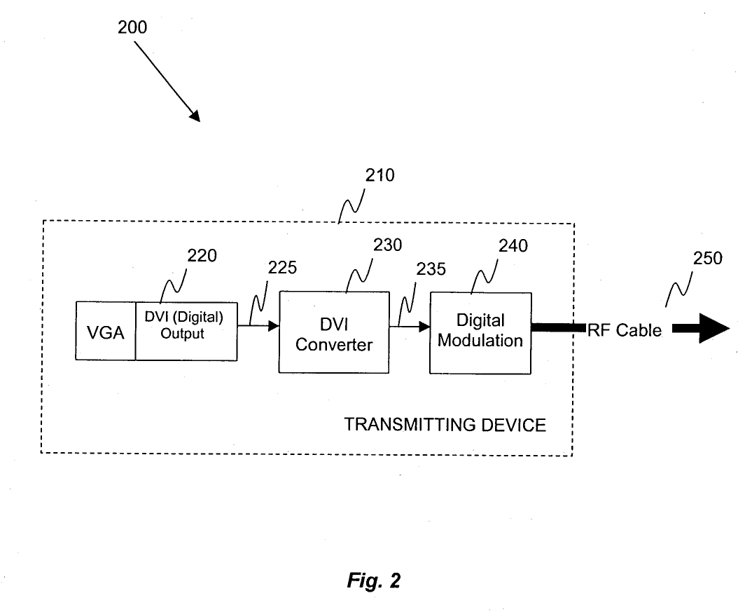

FIG. 2 illustrates a hardware environment 200 for transmitting digital video signals in a digital visual interface (DVI) format over an RF cable. DVI provides a high-speed digital connection for visual data types that is display technology independent. A DVI digital interface 220 provides a connection 250 between, for example, a video device or personal computing device and their display devices. However, the interface 220 is not limited to a video device or computer and their displays. The digital interface 220 has several benefits over the standard VGA connector. For example, a digital interface 220 ensures all contents transferred over this interface 220 remains in the lossless digital domain from the creation of the data to its consumption.

A DVI digital interface 220 provides that the viewable quality of a digital display will exceed the quality of a traditional analog CRT by increasing resolution resulting in a higher quality image. For example, in today's personal computers (PCs), the digital binary value of an image is converted by a graphics subsystem (e.g., graphics controller) to the analog signal required by the analog CRT, degrading the signal quality, i.e., pixel jitter.

By comparison, when a display adapter uses DVI, the image to be displayed does not go through this digital-analog conversion, preserving the original integrity of the digital signal until it reaches the display.

Another difference between analog and digital display interfaces is that the current generation analog displays must support multiple refresh rates and resolutions, something that adds cost to both the display and the graphics subsystem. Using a DVI interface, a digital display can have a fixed frequency and greater resolution, eliminating the need for multisync technology. With DVI, screen refresh functionality can be part of the display itself. New data needs to be sent to the display only when changes to the data need to be displayed. With this selective refresh interface, DVI can maintain the high refresh rates required to keep a CRT display ergonomically pleasing while avoiding an artificially high data rate between the graphics controller and the display.

In one embodiment of the present invention, a transmitter 210 of FIG. 2 provides a digital output signal 225 in a digital visual interface (DVI) format from a DVI interface 220 or graphics controller (not shown). The DVI interface 220 uses transition minimized differential signaling (TMDS) to convert data to the proper DVI format. The digital output signal 225 is converted into a parallel format by a DVI-to-parallel converter 230. Subsequently, the output signal 235 from the DVI-to-parallel converter 230 is transmitted to a digital modulator 240 coupled to the DVI converter 230. The digital modulator 240 modulates the output of the DVI converter 230 and transmits the signal over an RF cable 250. The digitally modulated signal on the RF cable 250 is capable of propagating over a long distance without the need of additional hardware such as repeaters and associated cabling.

In the present invention, audio, video and data information can be multiplexed together with a transmission header to form a signal block. This composite signal is then modulated (e.g., in the digital modulator 240). For example, quadrature phase shift keying (QPSK) modulation techniques, quadrature amplitude modulation (QAM) techniques, 8-level vestigial modulation (8VSB) or any other type of modulation that is suitable for the system 200 may be used. However, the present invention is not limited to any particular digital modulation technique.

Digital modulation provides numerous advantages over analog modulation. These advantages include but are not limited to the preservation of the fidelity of a digital message at low power levels, increased noise immunity by increased signal power, power efficiency and bandwidth efficiency.

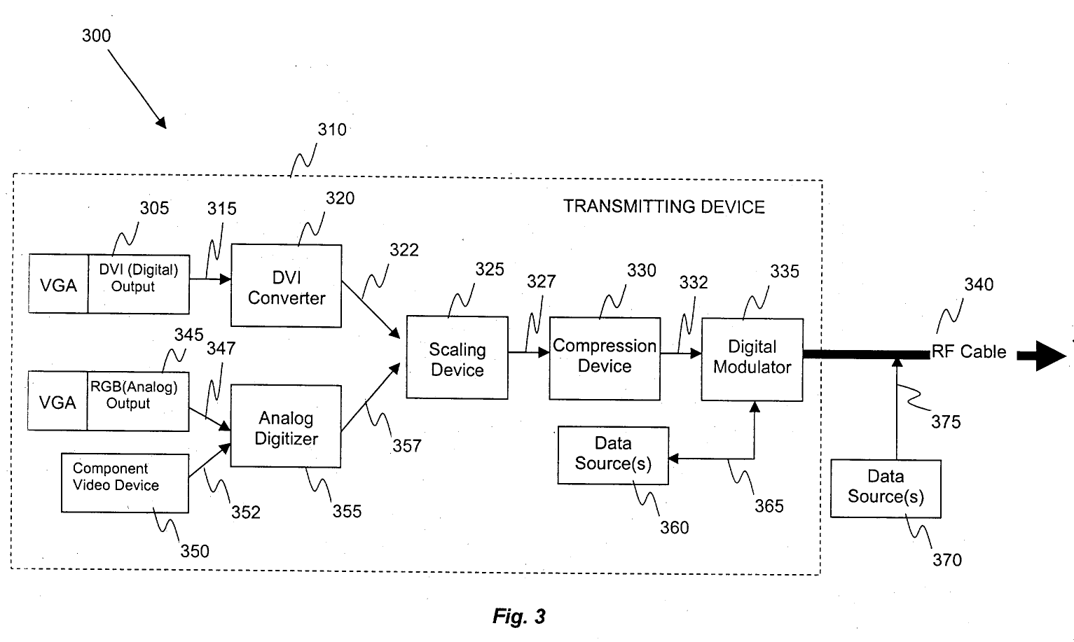

FIG. 3 illustrates another embodiment of a hardware environment 300 for transmitting digital video signals in a digital visual interface (DVI) format over an RF cable. In FIG. 3, a transmitting device 310 shows that a DVI digital output signal 315 from the DVI interface 305 is converted to a parallel format in the DVI-to-parallel converter 320. Also, analog output 347 from the analog interface 345, and video device output 352 from the component video device 350 are converted into a digital format in an analog digitizer 355. The output signals 322, 357, respectively, are scaled to a plasma native resolution by a scaling device 325.

The native resolution describes the actual resolution of a plasma display in contrast to the resolution of a delivery signal. In a typical display, the number rows of horizontal and vertical pixels that create the picture's resolution. Generally, the closer the incoming picture signal is to the native pixel resolution on the plasma display the better the picture. When a delivery format of a signal is higher or lower than a flat screen's native pixel resolution, the delivery signal will be converted to the plasma's native resolution through an internal converter. For example, a VGA computer signal of 853×480 will match up perfectly with a plasma display with 853×480 native pixel resolution, while an XVGA signal of 1024×768 will match up better with a plasma display that has the higher resolution of 1024×1024.

According to the present invention, the scaled signal 327 generated by the scaling device 325 may undergo lossless or visually lossless compression 330. Data may be compressed according to a method for multimedia data compression, which enables the data to be rapidly and efficiently transmitted to a remote display. The method of multimedia data compression according to the present invention adjusts the compression method according to the type of software application that generated the multimedia data, and hence according to the characteristics of the data itself. Preferably, a profile manager, which detects the characteristics of the multimedia data to determine the character of the data, selects the type of multimedia data compression according to the characteristics of that data.

The compressed output data 332 is digitally modulated 335 before being transmitted over an RF cable 340. Examples of digital modulation include but are not limited to 8VSB, QPSK and QAM. However, the present invention is not limited to any particular modulation technique. Information 365 from multiple data sources 360 are optionally digitally modulated with the compressed output data 332 in the digital modulator 335. For example, a central processing unit (CPU) may provide control data that will be digitally modulated along with the compressed output data 332.

Multiple information signals 375 from corresponding data sources 370 can be coupled to the RF cable 340 along with the output of the digital modulator 335. Accordingly, in keeping with the spirit of the present invention, the RF cable 340 may be a preexisting infrastructure already being used by other devices. Thus, the RF cable 340 in the present invention will accommodate multiple channels without signal degradation.

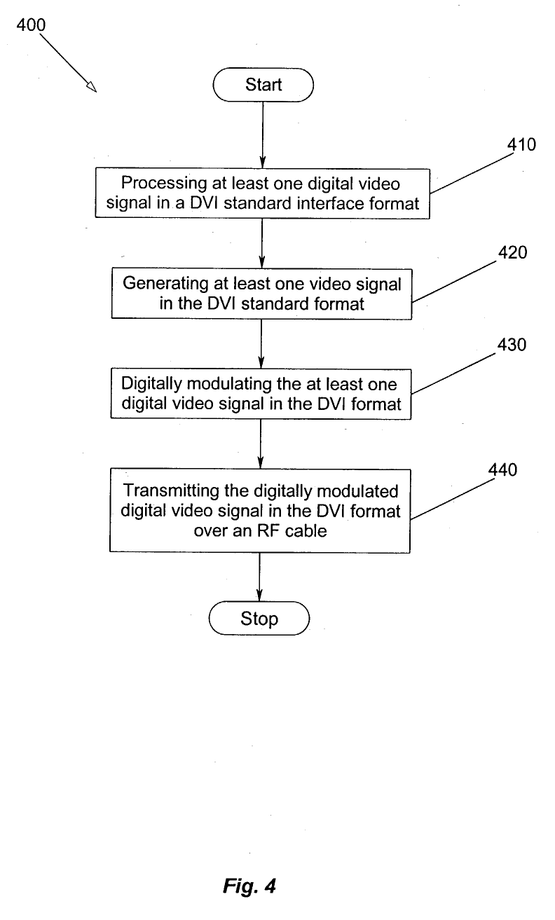

FIG. 4 is a flow chart 400 illustrating a method for transmitting digital video signals in a digital visual interface (DVI) format over an RF cable. A source device processes at least one digital video signal in a DVI standard interface 410. The processing of the digital video signals results in generating at least one video signal in the DVI standard format 420. The generated video signal in the DVI standard format is digitally modulated 430. The digitally modulated signal is then transmission over an RF cable 440. The digitally modulated signal can be transmitted over long distances via the RF cable without the need of additional hardware, such as repeaters.

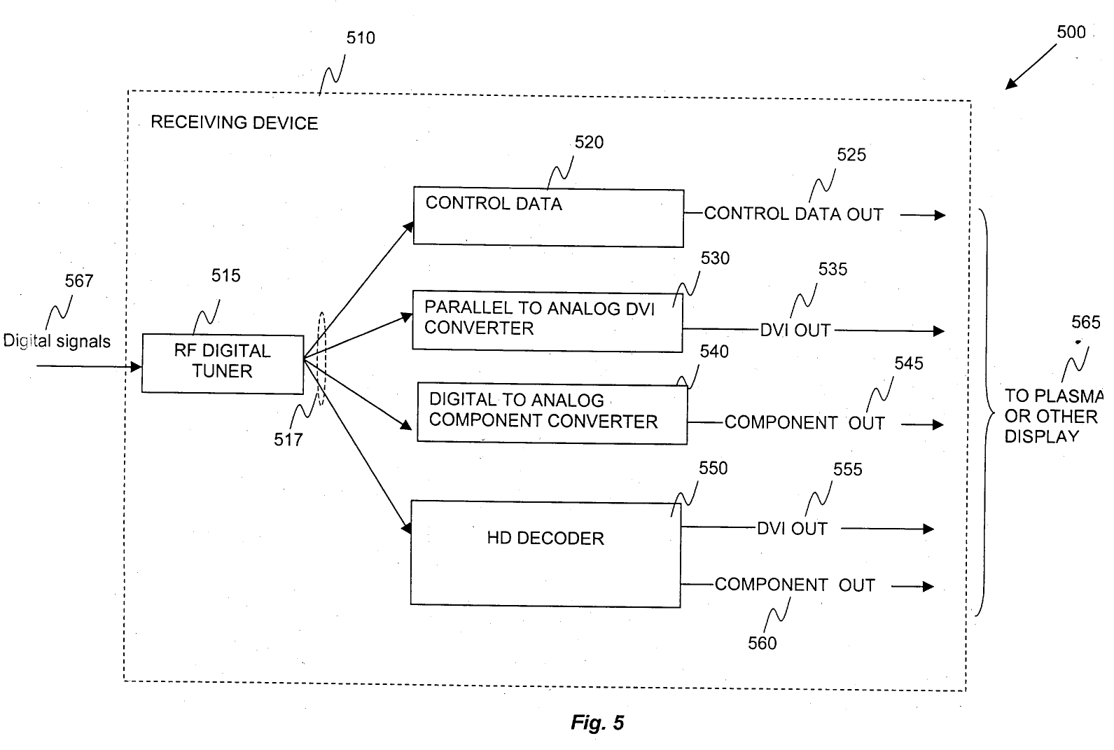

FIG. 5 is a functional block diagram of a RF digital cable receiving system 500 in accordance with the invention. A receiving device 510 includes an RF digital tuner 515 for receiving at least one digitally modulated signal 567. An RF digital tuner 515 processes the digitally modulated signal 567. Various modules 520, 530, 540, 550 process the output signal 517 of the RF digital tuner 515. These modules include, but are not limited to, a control data module 520 for generating control data 525, a parallel to analog DVI converter 530 for generating a DVI format signal 535, a digital to analog converter 540 for generating an analog signal 545, and an HD decoder for generating a DVI formatted signal 555 and component signal 560. These output signals 525, 535, 545, 555, 560 may be input signals to a display 565 such as a plasma display, any receiving device, or any similar device.

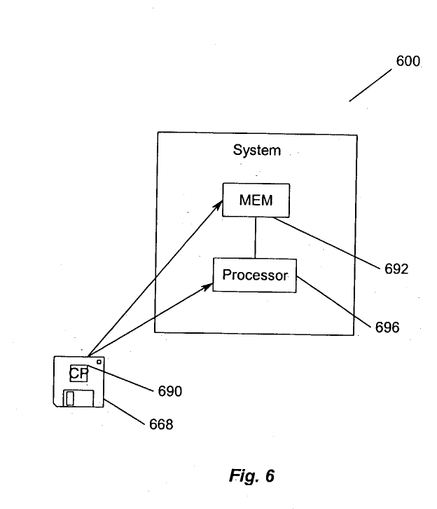

FIG. 6 illustrates a system 600 that is configured to transmit digital video signals in a digital video interface format over an RF cable according to the invention using an executable program readable from a storage driver program. The process illustrated with reference to the present invention may be tangibly embodied in a computer-readable medium or carrier, e.g. one or more of the fixed and/or removable data storage devices 668 illustrated in FIG. 6, or other data storage or data communications devices. A computer program 690 expressing the processes embodied on the removable data storage devices 668 may be loaded into the memory 692 or into the system 600, e.g., in a processor 696, to configure the system 600 of FIG. 6, for execution. The computer program 690 comprise instructions which, when read and executed by the system 600 of FIG. 6, causes the system 600 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method of transmitting digital video signals in a digital visual interface format, comprising:
processing at least one digital video signal in a digital visual interface standard interface to generate at least one video signal in a digital visual interface format; and
digitally modulating the at least one video signal in the digital visual interface format for transmission over an RF cable.

2. The method of claim 1 further comprising scaling the at least one video signal in the digital visual interface format to plasma native resolution prior to digitally modulating the at least one digital video signal.

3. The method of claim 2 further comprising combining a signal with the scaled video signal in the digital visual interface format prior to being digitally modulated.

4. The method of claim 3, wherein the combining the signal with the scaled video signal further comprises combining a control signal with the scaled video signal in the digital visual interface format prior to being digitally modulated.

5. The method of claim 2 further comprising compressing the scaled video signal in the digital visual interface format prior to being digitally modulated.

6. The method of claim 5 wherein the compressing comprises using visually lossless compression.

7. The method of claim 1 wherein the processing further comprises performing a digital visual interface serial-to-parallel conversion.

8. The method of claim 1 further comprising transmitting multiple digitally modulated signal in the digital visual interface format via the RF cable.

9. A method of transmitting digital video signals over long distances using an RF cable, comprising:
digitally processing at least one video signal to generate at least one digital video signal at a plasma screen native resolution; and
digitally modulating the at least one digital video signal at the plasma screen native resolution for transmission over an RF cable.

10. The method of claim 9 wherein the processing the at least one video signal further comprises converting the at least one video signal to a parallel format.

11. The method of claim 9 wherein the processing the at least one video signal further comprises processing digitized analog video signals.

12. The method of claim 9 wherein the processing the at least one video signal further comprises processing digital component video signals.

13. The method of claim 9 wherein the processing the at least one video signal further comprises processing digital visual interface (DVI) signals.

14. The method of claim 9 further comprising compressing the at least one digital video signal at the plasma screen native resolution prior to being digitally modulated.

15. The method of claim 14 wherein the compressing comprises using visually lossless compression.

16. The method of claim 9 further comprising combining a signal with the at least one digital video signal at the plasma screen native resolution prior to being digitally modulated.

17. The method of claim 9 further comprising combining a control signal with the at least one digital video signal at the plasma screen native resolution prior to being digitally modulated.

18. The method of claim 9 further comprising transmitting multiple digitally modulated signal in the digital visual interface format on an RF cable.

19. A method of displaying digital video signals, comprising:
receiving, at a receiving device, at least one digitally modulated video signal in a digital visual interface format transmitted over the RF cable;
processing the at least one digitally modulated video signal to generate at least one video signal; and
displaying the at least one video signal on a display.

20. The method of claim 19 wherein the processing the at least one digitally modulated video signal further comprises generating at least one video signal in a parallel format.

21. The method of claim 19 wherein the processing the at least one digitally modulated video signal further comprises generating at least one digitized analog video signal.

22. The method of claim 19 wherein the processing the at least one digital modulated video signal comprises generating at least one digital component video signal.

23. The method of claim 19 further comprising decompressing the at least one digital modulated video signal.

24. A method of processing digital video signals, comprising:
processing, at a transmitting device, at least one digital video signal in a DVI standard interface to generate at least one video signal in the DVI standard format;
digitally modulating, at the transmitting device, the at least one video signal in the DVI standard format for transmission over an RF cable; and
receiving, at a receiving device, the at least one digitally modulated video signal in the DVI standard format transmitted over the RF cable.

25. The method of claim 24 wherein the processing the at least one digital video signal further comprises converting the at least one digital video signal to a parallel format.

26. The method of claim 24 wherein the processing further comprises processing digitized analog video signals.

27. The method of claim 24 wherein the processing further comprises processing digital component video signals.

28. The method of claim 24 further comprising compressing the at least one digital signal at a plasma screen native resolution prior to being digitally modulated.

29. The method of claim 28 wherein the compressing comprising using visually lossless compression.

30. The method of claim 28 further comprising combining a signal with the at least one digital video signal at the plasma screen native resolution prior to being digitally modulated.

31. The method of claim 30, wherein combining the signal further comprises combining a control signal with the at least one digital video signal at the plasma screen native resolution prior to being digitally modulated.

32. The method of claim 24 wherein the receiving the at least one digitally modulated video signal further comprises generating at least one digitized analog video signal.

33. The method of claim 24 wherein the receiving the at least one digital modulated video signal comprises generating at least one digital component video signal.

34. A system for transmitting digital video signals in a digital visual interface format, comprising:
a processor for processing at least one digital video signal in a DVI standard interface to generate at least one video signal in the DVI standard format; and
a modulator for digitally modulating the at least one video signal in the DVI standard format for transmission over an RF cable.

35. The system of claim 34 further comprising a compression device for scaling the at least one video signal in the DVI standard format prior to being digitally modulated.

36. The system of claim 35 wherein the compression device comprises a visually lossless compression device.

37. The system of claim 34 wherein the processor further comprises a converter for performing digital visual interface serial-to-parallel conversion.

38. The system of claim 34, wherein the modulator combines control signals with the at least one digitally modulated video signal.

39. A system for transmitting digital video signals in a digital visual interface format, comprising:
a memory for storing at least one video signal; and
a digital signal processor for processing the at least one video signal to generate at least one digital modulated video signal in the DVI standard format for transmission over an RF cable.

40. The system of claim 39 further comprising a compression device for scaling the at least one video signal in the DVI standard format prior to being digitally modulated.

41. The system of claim 39 wherein the compression device comprises a visually lossless compression device.

42. The system of claim 39 wherein the digital signal processor further comprises a converter for performing digital visual interface serial-to-parallel conversion.

43. The system of claim 39, wherein the digital signal processor combines control signals with the at least one digitally modulated video signal.

44. An article of manufacture comprising a program storage medium readable by a computer, the medium tangibly embodying one or more programs of instructions executable by the computer to perform a method for transmitting digital video signals in a digital visual interface format, comprising:
processing at least one digital video signal in a DVI standard interface to generate at least one video signal in a DVI standard format; and
digitally modulating the at least one video signal in the DVI standard format for transmission over an RF cable.
